(19) United States
(12) Patent Application Publication
(10) Pub. No.: US 2007/0283378 A1
(43) Pub. Date: Dec. 6, 2007

(54) Optical recording medium, and method for initializing the optical recording medium

(76) Inventors: HIroyuki Iwasa, Yokohama-shi (JP); Hajime Yuzurihara, Odawara-shi (JP); Hiroshi Deguchi, Yokohama-shi (JP); Mikiko Takada, Yokohama-shi (JP)

Correspondence Address: COOPER & DUNHAM, LLP, 1185 AVENUE OF THE AMERICAS, NEW YORK, NY, 10036, US

(21) Appl. No.: 11/714,366

(22) Filed: Mar. 5, 2007

(30) Foreign Application Priority Data
Jun. 3, 2006 (JP) 2006-060126

(51) Int. Cl. G11B 7/24

(52) U.S. Cl. 720/718

(57) ABSTRACT

An optical recording medium including a transparent substrate; and at least one multi-layer information layer located on the transparent substrate and including a phase change recording layer configured to record information by changing its phase between a crystallization state and an amorphous state, a protective layer, and a reflection layer, wherein the average of partial response signal-to-noise ratio (PRSNR) in all data regions of the recording medium is not less than 15.0 after one direct overwriting (DOW1) cycle and the standard deviation of inter-track distribution of PRSNR is not greater than 0.3.

### TECHNICAL FIELD

The present disclosure relates to an optical recording medium, and more particularly to a rewritable phase change optical recording medium which performing recording and reproduction using a blue laser. In addition, the present disclosure also relates to a method for initializing the optical recording medium.

### DISCUSSION OF THE BACKGROUND

Recently, with increase in volume of information, a need exists for a recording medium, in which a large amount of information can be recorded at a high speed and a high density and the information can be accurately reproduced. Phase change optical recording media which perform recording and reproduction using a light beam, particularly, phase change optical discs, are media which have high access rate and which have such advantages as to have good signal properties, and to be able to perform high density recording and one-beam overwriting.

Such phase change optical discs typically have a structure such that at least a first protective layer, a phase change recording layer which can reversibly achieve an amorphous phase and a crystalline phase, a second protective layer, a reflection layer made of a metal, and a resinous protective layer are overlaid in this order on a transparent substrate in which a recessed guide groove is formed so that a laser light beam can be scanned along the guide groove. In addition, there are laminated optical recording media having a structure such that two optical recording media are laminated with an adhesive layer therebetween, wherein at least one of the two optical discs has the above-mentioned layer structure.

The method for recording and reproducing signals in the above-mentioned optical recording media is as follows.

A focused laser beam irradiates the recording layer of an optical recording medium while rotating the optical recording medium at a constant linear velocity or a constant angular velocity using a rotating device such as motors. In this case, the recording layer changes its phase, i.e., achieves a crystalline state or an amorphous state, depending on the light irradiation conditions, resulting in formation of patterns having different phases (i.e., signals). Reproduction of such signals is performed utilizing the difference in reflectance between the portions of the recording layer having a crystalline state and the portions having an amorphous state.

The focused laser beam is modulated so as to have one of three output levels in intensity. In this regard, a laser beam having the highest output level (hereinafter referred to as the recording power) is used for melting the recording layer. A laser beam having the medium output level (hereinafter referred to as the erasure power) is used for heating the recording layer to a temperature lower than the melting point of the recording layer and higher than the crystallization temperature of the recording layer. A laser beam having the lowest output level is used for controlling heating and cooling of the recording layer.

When a laser beam having a record power irradiates a portion of the recording layer, the portion is melted. The melted portion is then rapidly cooled. In this case, the portion achieves an amorphous state or a microcrystalline state and therefore has a low reflectance, resulting in formation of a record mark (a amorphous mark). When a laser beam having an erasure power irradiates a portion of the recording layer, the portion achieves a crystalline state independently of the previous state of the portion, resulting in erasure of information. Thus, by irradiating a recording layer with a laser beam while changing the intensity of the laser beam, crystalline portions and amorphous portions are formed therein, resulting in storage of information in the recording layer.

The above-mentioned layers of an optical recording medium are typically formed by a vacuum film forming method such as sputtering and vacuum evaporation methods. Immediately after the film forming process, the resultant recording layer achieves a state (as-depo. state) such that at least a portion of the recording layer has an amorphous state or a semi-stable crystalline state. The recording layer in the as-depo. state typically has a low reflectance and therefore auto focusing operations or tracking operations performed by a driving system for CDs or DVDs become unstable. Therefore, an initialization operation is typically performed on a recording medium to crystallize the recording layer thereof before recording.

Until now, DVD type rewritable phase change optical recording media which can record information at a quad speed (i.e., a linear velocity of 14.0 m/s) have been developed. However, a need exists for a rewritable optical recording medium which can perform higher speed recording. In addition, with increase in volume of information handled by computers, there is a need for higher density recording.

In order that a recording layer can perform high speed recording, the phase change material used for the recording layer has to have a high crystallization speed to an extent such that the recording layer can achieve a crystalline state at such high speed recording. For example, published unexamined Japanese patent application No. (hereinafter referred to as JP-A) 2004-322630 discloses Ga—Sb based phase change materials (such as Ga—Sb—Sn based materials and Ga—Sb—Sn—Ge based materials) as phase change materials capable of performing high speed recording.

In addition, in order to perform high density recording, the following techniques have been proposed:

(1) a laser beam having a relatively short wavelength (such as blue laser beams) is used; and
(2) the numerical aperture (NA) of the objective lens used for pickups for use in recording and reproduction is increased to decrease the size of a laser beam spot formed on an optical recording medium.

Specifically, Blu-ray Discs are commercialized and HD DVD-RWs are under development.

However, with increase in record density of optical recording media, an initial recording property deterioration problem in that the initial recording properties of a recording medium deteriorate after several recording operations easily occurs. In addition, an uneven initialization problem occurs in that when a medium is initialized by a conventional method (mentioned below), the properties vary in the medium depending on the properties of the light source used for the initialization, and thereby the properties of recorded portions greatly vary. Specifically, the problem is that the recording medium has a low erasure rate after two recording operations (hereinafter referred to as “one direct overwriting” or “DOW1”) to ten recording operations, and the medium can have good erasure rate after about ten or more direct overwriting cycles. The reason thereof is considered to be that the crystalline state of the medium just after the initialization operation is different from the crystalline state of the recording medium, which is achieved by overwriting a mark (having an amorphous state), and therefore the recording medium has uneven reflectance. Therefore, it is considered to be preferable that the initialization operation is performed under the same conditions as the erasure conditions in the overwriting operation.

The above-mentioned uneven initialization problem means that recorded portions of a recording medium have different reflectances due to the uneven initialization (i.e., the recording medium has a reflectance distribution). FIG. 1A is a view illustrating the reflectance (reflectance signal) of a recording medium which is irradiated with a laser beam to have a crystallization state near an amorphous state. It is clear that the medium has an even reflectance. FIG. 1B is a view illustrating the reflectance of the recording medium when the initialization power density of the laser is decreased by 20% compared to the case of FIG. 1A. Therefore the medium has initialization omissions. FIG. 1C is a view illustrating the reflectance of the medium when the initialization power density of the laser is increased or the scanning linear speed is lowered. The recording medium has unevenly initialized portions. The uneven initialization causes variation of recording properties of the recording medium. As a result, it becomes difficult for the recording medium to have good recording properties in all the data regions of the recording medium.

Particularly, the reflectance and the amplitude of signals of a HD DVD-RW using a reproduction signal detection method called PRML (Partial-Response Maximum-Likelihood) in which reproduction signals are equalized into multi-valued signals are largely influenced by such uneven initialization. Thus, the uneven initialization largely varies the recording properties of the recording medium.

Conventional methods for initializing optical recording media are as follows.

In a case of a recording medium having a disc-form, the recording medium is irradiated with an elliptical-form laser beam whose long axis extends in the radial direction of the medium while being rotated at a specific linear velocity. In this regard, the laser beam is moved in the radial direction of the recording medium by a distance which is shorter than the long-axis diameter of the laser spot (i.e., the half width of the intensity distribution curve of the laser beam in the long-axis direction thereof). Thus, the recording medium is gradually crystallized. This method is broadly used. Specific examples of the laser light source include laser diodes, gas lasers, etc. Among these light sources, large-scale laser diodes are widely used because of having good productivity.

In order that a recording medium has the same crystallization state as that of the recording medium after an overwriting operation, it is preferable to use a simple method in which each track of the recording medium is initialized at the same linear velocity as the recording velocity (i.e., overwriting velocity) using the same kind of light source as that used for recording, instead of a large laser diode. By using this method, occurrence of the uneven initialization problem can be prevented, and all the data regions of the thus initialized recording medium have good even recording properties. However, it takes a long time to perform such an initialization operation, resulting in deterioration of productivity. In addition, as mentioned above, the recording layer in the as-depo. state has a low reflectance and therefore auto focusing operations or tracking operations performed by a driving system for CDs or DVDs become unstable, thereby causing defective initialization.

In attempting to solve the initial recording property deterioration problem and the uneven initialization problem, JP-As 10-112065, 11-273071, 2000-195112 and 2002-92887 have disclosed initialization methods. However, an initialization method by which optical recording mediums can be initialized so as to have good properties in all the data regions has not yet been developed. Therefore, an optical recording medium having even properties in all the data regions has not yet been obtained.

Because of these reasons, a need exists for an optical recording medium which can perform overwriting using a blue laser and which does not cause the initial recording property deterioration problem and the uneven initialization problem.

### BRIEF SUMMARY

As an aspect of the present disclosure, an optical recording medium is provided which includes a transparent substrate, and at least one multi-layer information recording layer formed on the transparent substrate. The multi-layer information layer includes at least a phase change recording layer configured to record information utilizing phase change between a crystallization state and an amorphous state, a protective layer and a reflection layer. The data regions of the optical recording medium have an average partial response signal-to-noise ratio (PRSNR) of not less than 15.0 after one direct overwriting (i.e., DOW1) cycle and the standard deviation of the inter-track distribution of PRSNR is not greater than 0.3.

The transparent substrate preferably has a wobbling groove which has a depth of from 18 to 30 nm and a width of from 0.15 to 0.25 μm and which is formed at a pitch of 0.40±0.01 μm.

It is preferable that the optical recording medium is a disc and is initialized by a method including irradiating the disc with a rectangular or elliptical-form laser beam whose long axis extends in the radial direction of the recording medium while rotating the disc at a predetermined linear velocity and moving the laser beam in the radial direction of the disc by a distance which is shorter than the long-axis diameter of the laser spot (i.e., the half width of the laser beam in the long-axis direction thereof) per one revolution of the recording medium, wherein the laser beam has an intensity profile such that a maximum peak is present on a rear side of the profile relative to the moving direction of the beam spot (i.e., the radial direction of the recording medium).

These and other objects, features and advantages of the subject matter of the present disclosure will become apparent upon consideration of the following description of preferred embodiments of the present disclosure taken in conjunction with the accompanying drawings.

### BRIEF DESCRIPTION OF THE DRAWINGS

FIG. 1A is a view illustrating the reflectance (reflectance signal) of an optical recording medium having a crystallization state near an amorphous state;

FIG. 1B is a view illustrating the reflectance of the recording medium when the power density of the laser used for initialization is decreased by 20% compared to the case of the medium illustrated in FIG. 1(A);

FIG. 1C is a view illustrating the reflectance of the recording medium when the power density of the laser used for initialization is increased or the initialization linear speed is lowered compared to the case of the medium illustrated in FIG. 1(A);

FIG. 2A is a view illustrating the reflectance (reflectance signal) of an optical recording medium after crystallization occurs;

FIG. 2B is a view illustrating inter-track distribution of PRSNR of the recording medium after DOW1;

FIG. 3 is a graph illustrating the relationship between the initialization speed and the recording properties of the medium;

FIG. 4 is a graph illustrating the relationship between the initialization speed and the optimum initialization power density;

FIGS. 5A-5F are views illustrating examples of the intensity profile of a laser beam for use in initializing operation;

FIG. 6 is a view illustrating the cross section of an example of an optical recording medium, according to a preferred embodiment of the present disclosure;

FIG. 7 is a view illustrating the cross section of another example (i.e., a double-layer recording medium) of an optical recording medium, according to a preferred embodiment of the present disclosure;

FIG. 8 is a view illustrating the cross section of another example (i.e., a Blu-Ray disc), according to a preferred embodiment of an optical recording medium of the present disclosure;

FIGS. 9A-9B are views illustrating the intensity profiles of laser beams used for comparative examples;

FIG. 10 is a view illustrating the recording layer of the initialized optical disc of Example 1 when the recording layer is observed with an optical microscope;

FIG. 11 is a view illustrating the recording layer of the initialized optical disc of Comparative Example 1 or 4 when the recording layer is observed with an optical microscope;

FIG. 12 is a graph illustrating variation of PRSNR of an optical disc after DOW1; and

FIG. 13 is a view for explaining how vertical stripe patterns are formed in an initialization operation.

### DETAILED DESCRIPTION OF PREFERRED EMBODIMENTS

The present inventors discover that an optical recording medium which does not cause the initial recording property deterioration problem and the uneven initialization problem can be provided by initializing the optical recording medium using a laser beam having a specific beam profile in the radial direction of the recording medium so that the recording medium achieves a crystallization state near an amorphous state (namely, when the recording medium is initialized by a laser beam having an intensity slightly higher than that of the laser beam, the recording medium achieves an amorphous state).

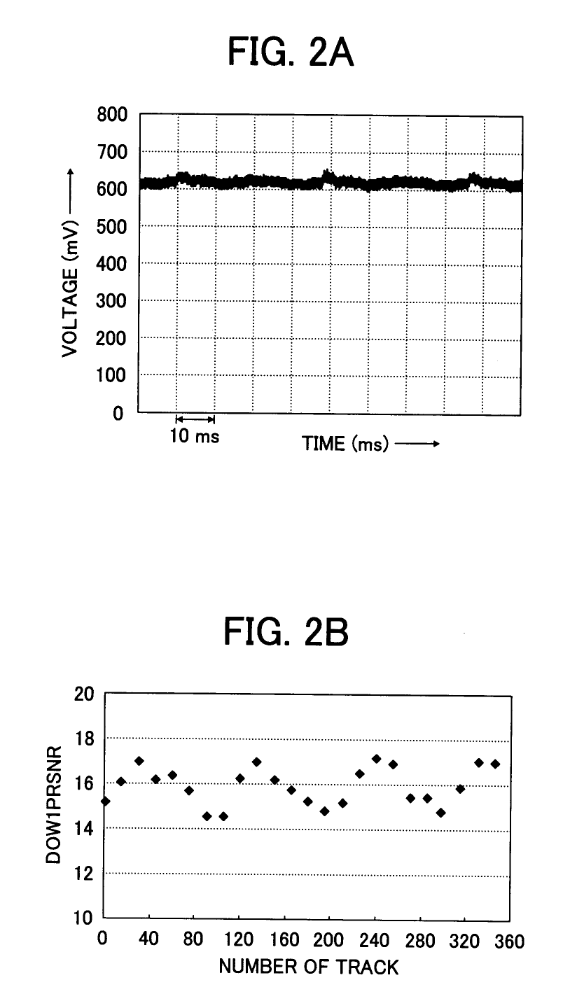

Specifically, the present inventors have made a study of the problems while drawing attention to the relationship between the deviation in after-initialization reflectance of high density optical recording media using phase change recording materials suitable for blue lasers and the standard deviation of PRSNR after DOW1 cycle (hereinafter referred to as DOW1PRSNR) of each of the tracks in all the data regions of the recording media after recording. As a result, it is found that even when the deviation in after-initialization reflectance of recording media is small, the recording properties of the recording media vary. FIG. 2A illustrates the reflectance (represented by the upper signal line) of one of the recording media after a crystallization operation. FIG. 2B illustrates the inter-track distribution of DOW1PRSNR of the most deteriorated recording portion of the recording medium. Referring to FIG. 2A, the recording medium has uniform reflectance. However, the recording property (i.e., DOW1PRSNR) of the recording medium varies (i.e., stable recording cannot be performed) as illustrated in FIG. 2B. In addition, it is also found that in order to stably perform recording on all the recording portions of a recording medium (i.e., in order to provide a stable recording system), the standard deviation of the inter-track distribution of DOW1PRSNR in all the data regions of the recording medium is preferably not greater than 0.3. A recording medium having such a good property can be provided by performing initialization on the recording medium using a laser beam having a beam profile such that a maximum peak is present on a rear side of the intensity distribution curve of the beam relative to the moving direction of the laser beam (i.e., the radial direction of the recording medium).

The recording property, PRSNR, is defined in part 1 (Annex H of Physical Specifications Version 0.9) of DVD Specifications for High Density Read-Only Disc from DVD Format/Logo Licensing Corporation, incorporated herein by reference. The method for determining PNSNR of a medium is also described therein.

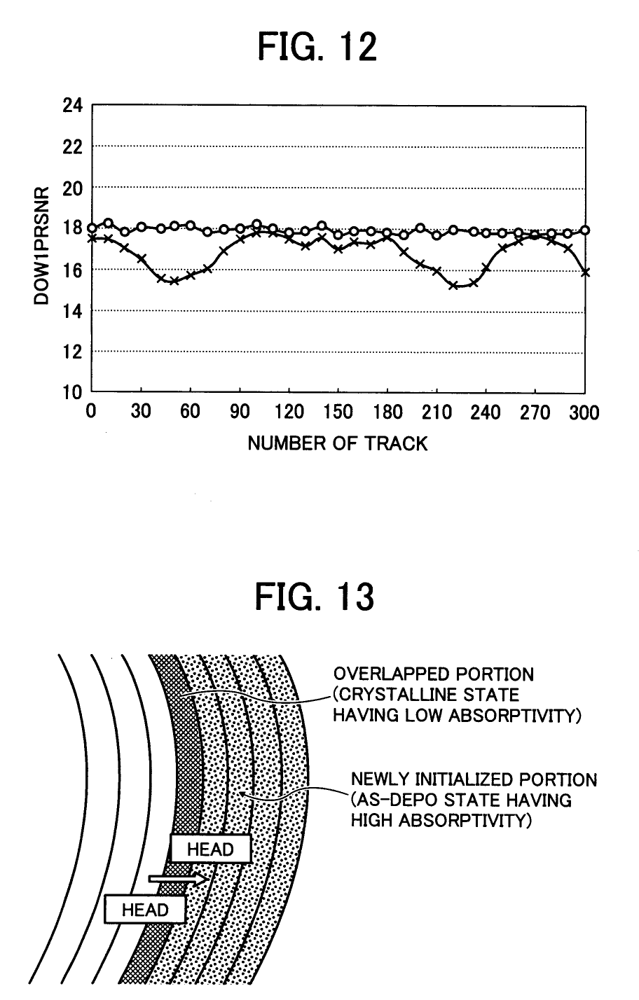

FIG. 12 illustrates DOW1PRSNR(O mark) of a recording medium satisfying the requirements of a preferred embodiment of the present disclosure, and DOW1PRSNR (X mark) of a recording medium not satisfying the requirements of the preferred embodiment of the present disclosure. It is clear from FIG. 12 that the variation in DOW1PRSNR of the recording medium (the medium of Example 1 mentioned below) satisfying the requirements of the preferred embodiment of the present disclosure is small, and the variation in DOW1PRSNR of the recording medium (the medium of Comparative Example 1 mentioned below) not satisfying the requirements of the preferred embodiment of the present disclosure is large.

In addition, the present inventors discover that the variation in DOW1PRSNR in each track (i.e., deterioration of initial recording properties after several repeated recording) is important particularly for optical recording media having a transparent substrate, on which a wobbling groove having a depth of from 18 nm to 30 nm and a width of from 0.15 to 0.25 μm is formed at a pitch of 0.40±0.01 μm, and a multiple information layer located on the substrate.

By performing initialization on such recording media using a laser beam having a beam intensity profile such that a maximum intensity peak is present on a rear side of the intensity distribution curve of the beam relative to the moving direction of the laser beam (i.e., in the radial direction of the recording medium to be initialized), the media have good high density recording properties such that the average of DOW1PRSNR in all the data regions is not less than 15.0 and the inter-track standard deviation of DOW1PRSNR is not greater than 0.3. Namely, recording media having uniform recording properties in all the recording portions can be provided, and a stable recording system can be provided. It is more preferable that the average of DOW1PRSNR in all the data regions is not less than 16.0 to provide a more stable recording system can be provided.

The initialization operation is preferably performed using a rectangular or elliptical-form laser beam which has a beam intensity profile such that the maximum intensity peak is present on a rear side of the intensity distribution curve of the beam relative to the moving direction thereof (i.e., the radial direction of the recording medium to be initialized). It is preferable that the intensity of the beam decreases from the maximum intensity peak in the moving direction of the beam (i.e., the long-axis direction of the rectangular or elliptical-form laser beam). By performing such an initialization operation on a recording medium, the recording medium has good high density recording properties without causing the initial recording property deterioration problem and the uneven initialization problem.

As a result of the present inventors' study, the following knowledge concerning the erasure conditions (i.e., crystallization conditions) in overwriting can be obtained.

In general, rewritable phase change materials for use in high density recording using a blue laser have high crystallization speed and therefore it is hard to form an amorphous mark. Therefore, in order to easily form an amorphous mark, a direct overwriting cycle is performed thereon after setting a rapid cooling environment. Specifically, it is preferable to use a recording medium having a rapid cooling structure such that a heat diffusion layer including In₂O₃ as a main component is formed or a reflection layer including Ag or an Ag alloy as a main component is formed, or an overwriting method in which a high recording power is applied while applying a low erasure power, so that heat is not stored in the recording medium, resulting in prevention of crystallization of amorphous marks after recording.

In a conventional initialization method using a light source having a large diameter, heat is stored in the entire of a recording medium and therefore it is impossible to set such a rapid cooling environment for the recording medium. In view of this situation, the present inventors have investigated whether or not to perform rapid cooling initialization by controlling the beam intensity profile of the laser beam used for initialization. As a result of the study of initialization, it is found that by using a laser beam having a beam intensity profile such that the maximum intensity peak is present on a rear side (or at a rear end) of the intensity distribution curve of the beam relative to the moving direction of the laser beam (i.e., the radial direction of the recording medium to be initialized) or the intensity of the laser beam decreases in the moving direction of the laser beam, the recording medium can achieve a crystallization state, which is the same as that of the medium after an overwriting operation, after the initialization operation.

Further, the present inventors have obtained the following knowledge concerning the uneven initialization problem.

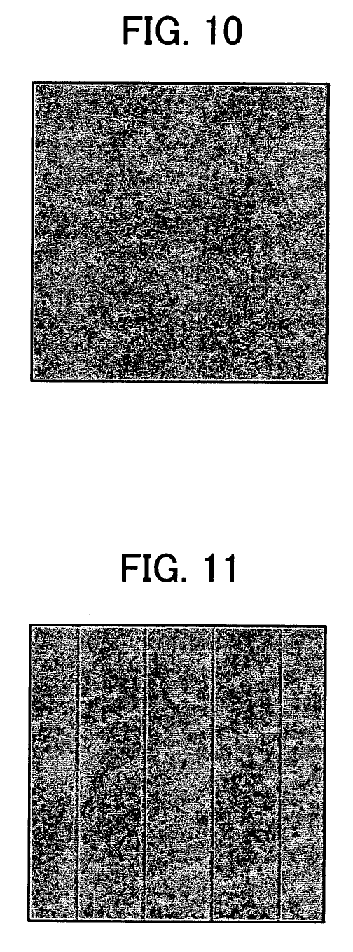

The present inventors observed the initialized optical recording media of Example 1 and Comparative Example 1 mentioned below using an optical microscope of 500 (10×50) power magnification. As a result of the observation, it is found that the medium of Comparative Example 1 has vertical stripe patterns formed at a certain pitch, which is the same as the feeding pitch of the laser beam in the moving direction of the beam as illustrated in FIG. 11, but the medium of Example 1 does not have such vertical stripe patterns as illustrated in FIG. 10 (namely, the medium of Example 1 is evenly initialized). In addition, the present inventors observed the initialized optical recording medium of Comparative Example 4, which was initialized using a laser beam having a profile such that the maximum intensity peak is present on a front side of the intensity distribution curve, it is found that the recording medium has the same vertical stripe patterns as those illustrated in FIG. 11.

Phase change recording materials such as Ge—Sb—Sn based materials, which can perform high speed recording, typically have a high crystallization temperature, and therefore a high power has to be applied to initialize a recording medium using such a phase change material. As a result of the present inventors' study, it is found that the uneven initialization problem in that uneven stripe patterns are formed at a pitch which is the same as the feeding pitch of the laser beam, is seriously caused as the initialization speed increases or the initialization power increases. The reason therefor is not yet determined but is considered as follows.

As mentioned above, conventional initialization methods use a rectangular or elliptical-form laser beam whose long axis extends in the moving direction of the beam (i.e., the radial direction of the recording medium to be initialized) and whose minor axis extends in the direction parallel to the tracks of the recording medium. In this regard, the laser beam is moved in the radial direction of the recording medium by a distance which is shorter than the long-axis diameter of the laser beam (i.e., the half width of the intensity distribution curve of the laser beam in the long-axis direction thereof). Thus, the recording medium is gradually crystallized. The reason why the moving distance is shorter than the long-axis diameter of the laser beam is to prevent formation of non-initialized portions in the recording medium. For example, when a laser head having a diameter of 75 μm is used, the moving distance is set to be 50 μm/r, which is two thirds of the diameter of the laser beam spot. Therefore, some portions of the recording medium (hereinafter referred to as overlapping portions) are exposed to a laser beam twice. The overlapping portion is illustrated as a darkest portion in FIG. 13. When a laser beam irradiates the overlapping portion at the second time, the portion has achieved a crystallization state and therefore the portion has a smaller light absorptivity than the adjacent portions, which is not yet exposed to the laser beam. Therefore, the overlapping portions and the other portions are initialized under different conditions. Accordingly, the vertical stripe patterns as illustrated in FIG. 11 are formed due to this uneven initialization.

Similarly, it is considered that in the first recording layer of a recording medium having plural recording layers, the overlapping portions and the other portions thereof are initialized under different conditions. Accordingly, the vertical stripe patterns as illustrated in FIG. 11 are formed in such a recording layer due to the uneven initialization.

Therefore, in order to evenly initialize a recording medium, it is preferable to use a laser beam having a beam intensity profile such that the intensity of the rear portion of the laser beam, which irradiates the overlapping portions having a small absorptivity, is increased. Accordingly, in the preferred embodiment of the present disclosure, the initialization operation is preferably performed using a rectangular or elliptical-form laser beam which has a beam intensity profile such that the maximum intensity peak is present on a rear side (or at the end portion) of the intensity distribution curve of the laser beam relative to the moving direction thereof (i.e., the radial direction of the recording medium) in order to perform even initialization. Alternatively, it is also preferable that the intensity of the beam decreases from the maximum intensity peak in the moving direction of the laser beam (i.e., the long-axis direction of the rectangular or elliptical laser beam). By using these initialization methods, an optical recording medium having good recording properties in all the data regions can be provided.

When phase change materials having a maximum recording velocity of from 6.61 to 13.22 m/s (i.e., single to double HD DVD speed) are used for the recording layer of a recording medium, it is preferable to use an initialization method in which the recording medium is rotated at a velocity of from 3 to 14 m/s. In this case, the resultant initialized recording medium has good recording properties.

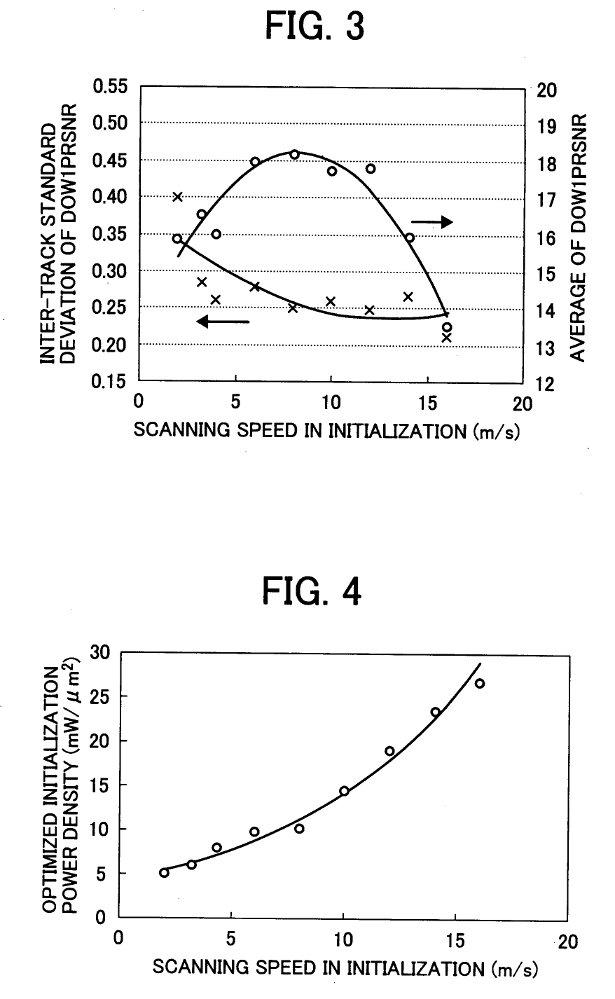

FIG. 3 illustrates the relationship between the scanning speed in initialization (i.e., the rotation velocity of a medium) and the average of DOW1PRSNR(O mark) or the inter-track standard deviation σ (x mark) of DOW1PRSNR. The recording medium is the same as the medium of Example 1 except that a phase change material, Ge_{5.0}Ag_{0.5}In₂Sb₇₇Te_{15.5}, is used for the recording layer. It is clear from FIG. 3 that there is a case where the average of DOW1PRSNR is not less than 15.0 but the inter-track standard deviation of DOW1PRSNR is large. Namely, in that case, some portions of the initialized recording medium have deteriorated recording properties depending on the location of the portions.

FIG. 4 illustrates the relationship between the rotation velocity of the recording medium and the optimized initialization power density of the laser beam used. Namely, it is preferable that the recording medium is initialized by applying a laser beam having a power density of from 5 to 25 mW/μm² thereto while rotating the recording medium at a rotation velocity of from 3 to 14 m/s. In this case, the recording medium has good recording properties.

In the preferred embodiment of the present disclosure, it is preferable to use Sb—Te based phase change materials, which have a good combination of recording sensitivity (good sensitivity in achieving an amorphous state) and erasure ratio, for the recording layer of the recording medium, particularly the multi-layer recording medium. In this case, the recording medium has good recording properties and good sensitivity. In addition, the recording medium can be easily initialized and the initialized recording medium has sharp reflectance distribution. In this regard, the Sb—Te based materials are defined as materials in which total content of Sb and Te in the materials is not less than 90 atomic %.

It is also preferable to use Ge—Sb—Sn based phase change materials for the optical recording medium, in the preferred embodiment of the present disclosure, because the recording medium can perform rewriting using a blue laser and has good recording properties even at a relatively high recording velocity of from 6.61 to 13.22 m/s while having a good preservation reliability. In addition, the recording medium can be easily initialized and the initialized recording medium has a sharp reflectance distribution. In this regard, the Ge—Sb—Sn based materials are defined as materials in which total content of Ge, Sb and Sn in the materials is not less than 90 atomic %.

The first main element Sb is essential for high speed recording. By changing the ratio of Sb, the crystallization speed of the recording medium can be adjusted. Specifically, by increasing the ratio of Sb, the crystallization speed can be increased. However, recording media including only Sb have poor recording properties after repeated use and poor preservation reliability. In order to improve such properties, a second essential element Ge is added. Since the preservation reliability can be dramatically improved by adding a small amount of Ge, the component Ge is essential. Ge—Sb based phase change materials are suitable for high speed recording, but have such a problem as to have a low modulation degree and a low reflectance when a blue laser is used. In order to improve the properties while maintaining good crystallization speed, a third essential element Sn is added thereto.

It is more preferable for the Ge—Sb—Sn based phase change materials to include at least one element selected from the group consisting of In, Te, Al, Ga, Zn, Mg, Tl, Bi, Se, C, N, Au, Ag, Cu, Mn and rare earth elements, in an amount of, preferably, from 0.1 to 10 atomic %, and more preferably from 0.5 to 8 atomic %.

The recording layer of the optical recording medium in the preferred embodiment of the present disclosure preferably has a thickness of from 4 to 18 nm. It is hard to form a uniform recording layer thinner than 4 nm. When the recording layer is too thick, the resultant optical recording medium has low recording sensitivity. When the recording medium is a two-layer recording medium, the first information layer is required to have a high transparency. Therefore the recording layer of the first information layer preferably has a thickness of not greater than 10 nm so that the recording layer has a high transparency.

The optical recording medium in the preferred embodiment of the present disclosure may be a multi-layer recording medium in which a first information layer to an N-th information layer (N is an integer of not less than 2) are overlaid in this order on a transparent substrate. It is preferable that at least one of the information layers has the above-mentioned multi-layer structure (i.e., includes at least a recording layer, a protective layer and a reflection layer). The optical recording medium has good properties and small in-plane variation in the properties.

It is preferable for the multi-layer recording medium that the first information layer includes at least a first lower protective layer, a first recording layer, a first upper protective layer, a first reflection layer, and a first heat diffusion layer, which are overlaid in this order, and the second information layer includes at least a second lower protective layer, a second recording layer, a second upper protective layer and a second reflection layer, wherein the laser beam irradiates the recording medium from the first lower protective layer side. In this two-information-layer recording medium, the first and second information recording layers have a good combination of recording sensitivity and recording properties such as PRSNR and modulated signal amplitude.

It is preferable that an interface layer is formed between the first protective layer and the first recording layer and/or between the first recording layer and the upper protective layer, in order to prevent migration of a material between the layers during repeated recording operations or to accelerate crystallization of the recording layer, thereby improving the repeated recording properties of the recording medium.

In the multi-layer recording medium, the first heat diffusion layer preferably includes a material including In₂O₃ as a main component, such as indium tin oxides (ITOs) and indium zinc oxides (IZOs). Since such a material has a low absorptivity and a high heat conductivity, the first information layer has a good combination of transparency, recording sensitivity and erasure ratio. The first heat diffusion layer preferably has a thickness of from 10 to 200 nm. When the heat diffusion layer is too thin, good heat diffusion effect cannot be produced. When the first heat diffusion layer is too thick, not only the repeat recording properties but also productivity of the recording medium deteriorate.

Pure silver or a silver alloy is preferably used for the reflection layer. This is because the materials have good heat conductivity and thereby the recording layer heated to a high temperature in a recording operation can be rapidly cooled by the reflection layer, resulting in formation of amorphous marks. When the reflection layer includes Ag and the upper protection layer includes a sulfur-containing material, such as mixtures of ZnS and SiO₂, a problem in that the reflection layer is corroded due to a reaction of S with Ag occurs. Therefore it is preferable to form a barrier layer (i.e., a sulfurization prevention layer) between the upper protective layer and the reflection layer.

The optical recording medium in the preferred embodiment of the present disclosure is initialized using a rectangular or elliptical-form laser beam whose long axis extends in the radial direction of the medium to be initialized while rotating the recording medium at a specific linear velocity and moving the laser beam in the radial direction of the recording medium, wherein the laser beam has a beam intensity profile such that the intensity of the laser beam has a maximum peak on a rear side of the intensity distribution curve relative to the radial moving direction of the laser beam. The initialization method will be explained in detail.

When the optical recording medium is a disc, the medium is gradually initialized (i.e., crystallized) by being irradiated with a rectangular or elliptical-form laser beam whose long axis extends in the radial direction of the recording medium to be initialized while the disc is rotated at a specific linear velocity. In this regard, the laser beam is moved in the radial direction by a distance which is shorter than the long-axis diameter of the laser beam (i.e., the half width of the laser beam in the long-axis direction thereof).

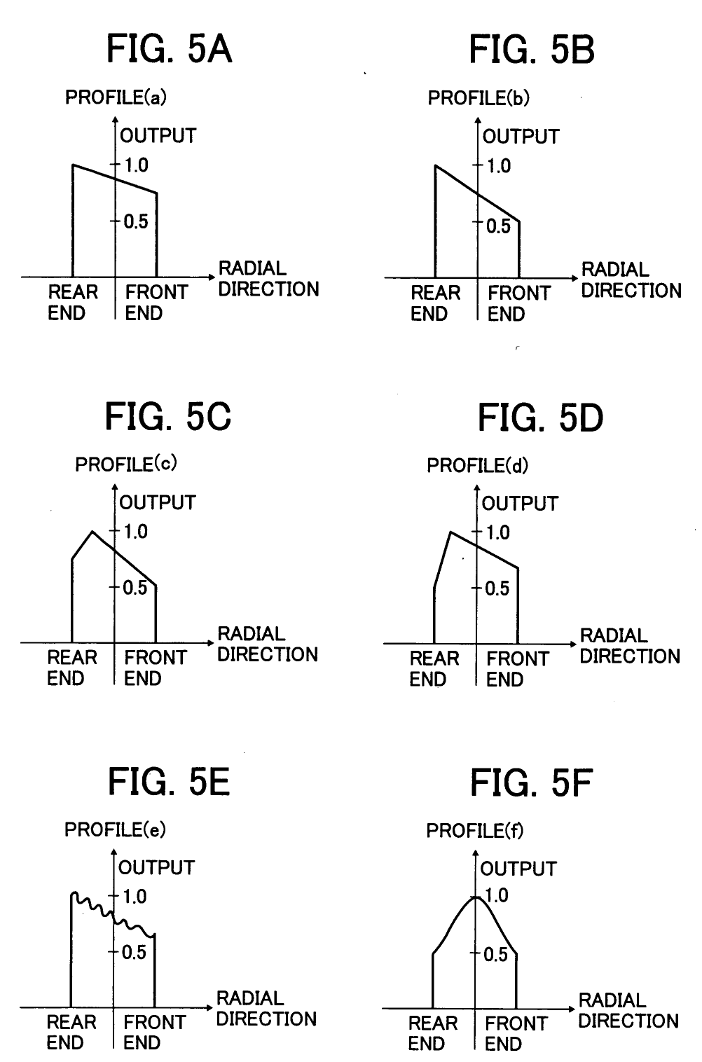

Examples of the beam intensity profile of the laser beam for use in initialization are illustrated in FIGS. 5A-5F. In the present application, the maximum intensity peak present on a rear side of the intensity distribution curve (i.e., profile) means a peak located at a point between the center and the rear end of the profile.

The ratio (MIN/MAX) of the intensity (MIN) of the minimum peak to the intensity (MAX) of the maximum peak in the profile is preferably from 0.50 to 0.90, and more preferably from 0.60 to 0.90. It is difficult to stably produce a laser beam having too small a ratio (MIN/MAX). In contrast, when the ratio is too large, the effect of the preferred embodiment of the present disclosure is hardly produced.

In view of uniformity of the layers and signal characteristics of the recording medium to be initialized and initialization efficiency, large-scale laser diodes are preferably used for initialization. Since the recent laser diodes have a peak power of about 4.0 W, the size (area) of the light source for use in initialization is preferably not greater than 150 μm², and more preferably not greater than 100 μm², in order to perform initialization while maintaining the power density of from 5 to 25 mW/μm². With respect to the size of the light source, there is no particular lower limit. However, the smaller the size (area) of the light source, the lower the initialization efficiency. Therefore, it is preferable to determine the size of the light source in consideration of the peak power of the laser diode used for the light source.

In order to prepare a laser beam having such a profile, a method in which a shield or a filter is set at a location between the beam irradiating entrance and the recording medium to be initialized or a method in which a laser light source is set so as to be slanting relative to the surface of the recording medium to be initialized can be used, but other methods can also be used.

The laser beam scanning speed (i.e., the speed in the track direction) of the laser beam is preferably controlled so as to be from 3 to 14 m/s to minimize the inter-track standard deviation of DOW1PRSNR in all the data regions of the recording medium to be initialized, i.e., to impart good and uniform recording properties to the entire recording medium.

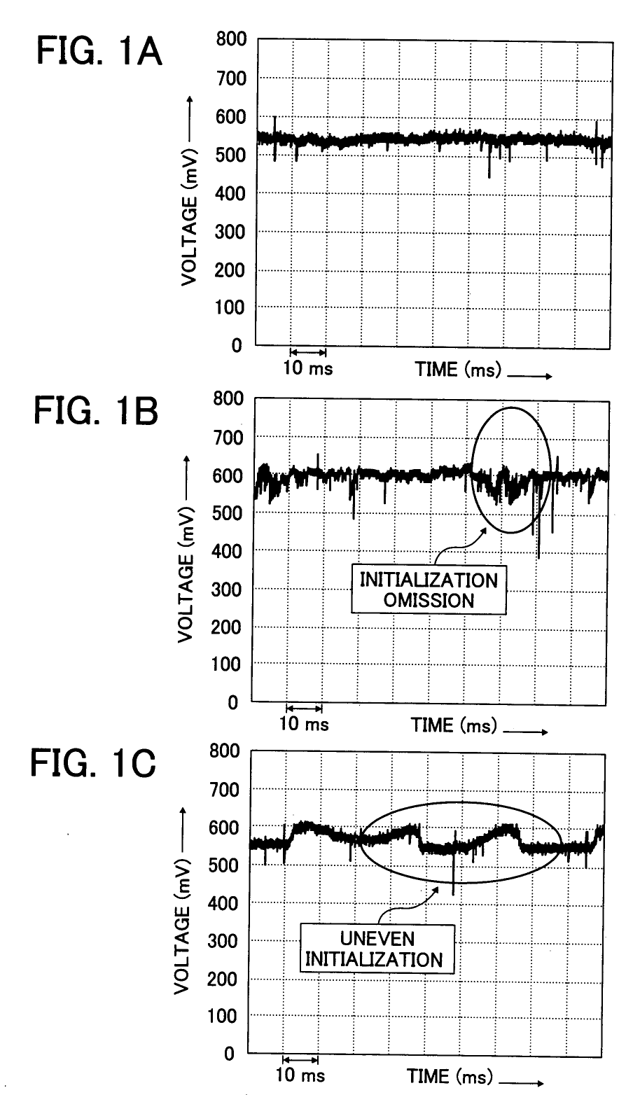

The laser beam preferably has a power density of from 5 to 25 mW/μm² in order that the initialized portion has a crystallization state near an amorphous state. When the power density is too high, the recording medium is heated to a high temperature, thereby thermally damaging the medium. When the power density is too low, the initialization omission phenomenon as illustrated in FIG. 1B occurs.

In the initialization operation, a laser beam scans the optical recording medium which is rotated at a specific linear velocity, wherein the laser beam has a rectangular or elliptical form such that the long axis of the beam extends in the radial direction of the recording medium. In this case, when the recording medium is rotated by one revolution, the laser beam is moved in the radial direction of the recording medium by a specific distance (hereinafter sometimes referred to as a moving distance). The moving distance is preferably shorter than the long axis diameter of the laser beam in order to prevent occurrence of the initialization omission problem. However, in order to improve the initialization efficiency and to prevent occurrence of the uneven initialization problem, the moving distance is preferably set a proper distance such that the area of the overlapping portion to which the laser beam irradiates plural times is as small as possible. In this case, the initialized recording medium has good recording properties after several repeated recording.

In order to zero the area of the overlapping portion, it is necessary that the moving distance of the laser beam is the same as the long-axis diameter thereof. In this case, since the laser beam has a beam profile, a problem in that a portion of the recording medium to which an end portion of the laser beam irradiates is insufficiently initialized occurs (i.e., the initialization omission problem occurs). Therefore, the moving distance is preferably set to a value of from L/n to (n−1)L/n, wherein L represents the size (i.e., half width) of the laser beam spot in the long-axis direction thereof, and n is an integer of from 2 to 10. In this regard, the moving distance is not necessarily equal to, for example, L/n (or (n−1)L/n), and can have allowance of about ±5%.

When the optical recording medium to be initialized has a form other than disc forms, it is preferable to perform initialization while minimizing the area of the overlapping portion.

The optical recording medium in the preferred embodiment of the present disclosure includes a transparent substrate, and a multi-layer information layer including at least a recording layer configured to record information by causing a phase change between a crystalline state and an amorphous state upon application of light thereto, a protective layer and a reflection layer. Preferably, the optical recording medium has a structure such that a lower protective layer, a recording layer, an upper protective layer and a reflection layer are formed in this order or vice versa. In this regard, a laser beam irradiates the recording medium from the lower protective layer side.

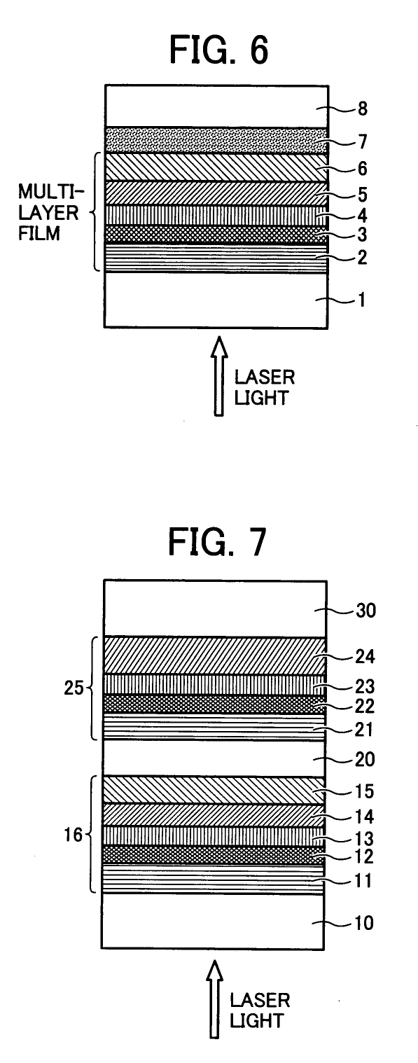

FIG. 6 is a schematic view illustrating the cross section of an example of the optical recording medium in the preferred embodiment of the present disclosure. The recording medium includes a transparent substrate 1 on which a guide groove is formed to guide the laser light; a lower protective layer 2; a recording layer 3 which can reversibly achieve an amorphous state and a crystallization state; an upper protective layer 4; a barrier layer 5; a reflection layer 6; and a resinous protective layer 7. These layers are formed in this order overlying the substrate 1. In this regard, “overlying” can include direct contact and allow for intermediate layers. In addition, a substrate 8 which is similar to the substrate 1 is adhered to the resinous protective layer 8 with an adhesive layer therebetween. The resinous protective layer is a layer which does not influence the recording/reproduction properties of the recording medium. The above-mentioned adhesive layer may serve as the resinous protective layer. Therefore the layer 8 is not essential and is excluded from the multi-layer film (i.e., information layer).

Next, each layer of the optical recording medium in the preferred embodiment of the present disclosure will be explained.

### Recording Layer

Various phase change materials can be used for the recording layer 3. Among these phase change materials, Sb—Te based phase change materials and Ge—Sb—Sn based phase change materials are preferably used for the recording layer 3.

Sb—Te based phase change materials can include not only one or more other elements such as Ag, In, Ge, Se, Sn, Al, Ti, V, Mn, Fe, Co, Ni, Cu, Zn, Ga, Bi, Si, Dy, Pd, Pt, Au, S, B, C, and P, but also impurities to further improve the performance and reliability of the materials. For example, Ag—In—Sb—Te based alloys and Ag—In—Ge—Sb—Te based alloys are preferable. Among these materials, phase change materials having the following formula can be more preferably used.

SbₐTe_{100-(a+b+c)}Ge_{b}M1_{c},

wherein 65≦a≦80, 1≦b≦10, 0.1≦c≦10, M1 is an element selected from the group consisting of Ag, In, Se, Sn, Al, Ti, V, Mn, Fe, Co, Ni, Cu, Zn, Ga, Bi, Si, Dy, Pd, Pt, Au, S, B, C, and P, and a, b and c represents the atomic percentages of the elements Sb, Ge and M1, respectively.

Ge—Sb—Sn based phase change materials have good high speed recording properties, and can include one or more other elements such as In, Te, Al, Ga, Zn, Mg, Tl, Bi, Se, C, N, Au, Ag, Cu, Mn, and rare earth elements. Specifically, phase change materials having the following formula can be preferably used.

Ge_{α}Sb_{β}Sn_{γ}M2_{δ},

wherein M2 is an element selected from the group consisting of In, Te, Al, Ga, Zn, Mg, Tl, Bi, Se, C, N, Au, Ag, Cu, Mn, and rare earth elements.

When the following relationships are satisfied: 5≦α≦25, 45≦β≦75, 10≦γ≦30, and 0≦δ≦15, the phase change materials have a low melting point and a large refractive index change Δn (i.e., the difference in refractive index between the crystalline state and the amorphous state. Therefore, the optical recording medium including the material in the recording layer thereof has high recording sensitivity and high contrast (i.e., large reflectance change).

When α is not less than about 5 atomic %, the stability of the medium against reproduction light can be improved. When α is not greater than about 25 atomic %, formation of plural phases can be prevented and therefore the recording medium can maintain good recording properties even after repeated recording. When β is not less than about 45 atomic %, the recording medium has high crystallization speed and good erasure ratio. When γ is not less than about 10 atomic %, the recording medium has high crystallization speed and large refractive index change Δn. When β is not greater than about 75 atomic % and γ is not greater than about 30 atomic %, formation of plural phases can be prevented and therefore the recording medium can maintain good recording properties even after repeated recording. Therefore, it is preferable that β is from 45 to 75 atomic %, and γ is from 10 to 30 atomic %. In addition, in order to impart good recording/reproduction properties to the recording medium (i.e., to control the crystallization speed), it is preferable to add another element M2 thereto. When the element M2 is added in an amount of from 0 to 15 atomic %, formation of plural phases can be prevented and therefore the recording medium can maintain good recording properties even after repeated recording.

Addition of In to high speed phase change materials prevents occurrence of defective initialization in the materials. However, addition of a large amount of In causes a problem in that the recording medium is deteriorated by reproduction light, resulting in decrease of reflection of the recording medium. Therefore, the added amount of In is preferably not greater than 10 atomic %.

Addition of an element such as Tl, Bi, Al, Mg, Mn, and rare earth elements enhances the crystallization speed of the recording medium. Among these elements, Bi is more preferable because of having the same valence with Sb. However, the added amount of such an element is preferably controlled so as to be not greater than 10 atomic % to prevent occurrence of problems in that the recording medium is deteriorated by reproduction light, and the initial jitter property deteriorates.

The preservation reliability can be improved by adding an element such as Te, Al, Zn, Se, C, N, Se, Au, Ag, and Cu instead of Ge. Among these elements, Al and Se can improve the crystallization speed of the recording medium, and Se can improve the recording sensitivity of the recording medium.

Addition of Au, Ag, and Cu can improve the preservation reliability of the recording medium while preventing occurrence of defective initialization. The added amount of total of Au, Ag, and Cu is preferably not greater than 10 atomic % not to decrease the crystallization speed (i.e., not to deteriorate high speed crystallization property). When the added amount thereof is too small, the effects cannot be produced. Therefore, the lower limit of the added amount of total of Au, Ag, and Cu is preferably not less than 0.1 atomic %.

Addition of Mn and a rare earth element can produce the same effects as those of In. Particularly, when Mn is added, the preservation reliability of the recording medium can be improved even when the added amount of Ge is small. The added amount of Mn is preferably from 1 to 10 atomic % to enhance the crystallization speed and to prevent decrease of the reflectance of non-recorded portions having a crystallization state.

By properly combining one or more of the above-mentioned elements with Ge—Sb—Sn based phase change materials, an optical recording medium which has such a high speed recording property as to be recorded in a maximum recording velocity range of from 6.61 to 13.22 m/s without causing the initialization problems and which has good preservation reliability can be provided.

The recording layer preferably has a thickness of from 4 to 18 nm, and more preferably from 6 to 15 nm to form a uniform recording layer and to prevent deterioration of recording sensitivity of the recording medium. As the recording layer becomes thicker, the effects of the preferred embodiment of the present disclosure can be easily produced. In contrast, as the recording layer becomes thinner, the erasure properties of the recording medium can be improved because the difference in absorptivity between the crystallization state and the amorphous state decreases.

In a case of two-information-layer optical recording medium, the first information layer is required to have a high transparency. Therefore, the thickness of the recording layer of the first information layer is preferably not greater than 10 nm.

### Lower and Upper Protective Layers

The lower and upper protective layers are formed to prevent the recording layer from deteriorating and to improve adhesion of the recording layer with adjacent layers and recording properties of the recording layer. Specific examples of the materials for use in the lower and upper protective layers include oxides such as SiO, SiO₂, ZnO, SnO₂, Al₂O₃, TiO₂, In₂O₃, MgO, ZrO₂ and Nb₂O₅; nitrides such as Si₃N₄, AlN, TiN, BN and ZrN; sulfides such as ZnS, In₂S₃ and TaS₄; carbides such as SiC, TaC, B₄C, WC, TiC and ZrC; diamond-like carbon; and mixtures thereof.

Among these materials, mixtures of ZnS and SiO₂ are preferably used for the layers because of having high heat resistance, low heat conductivity and good chemical stability. In addition, the protective layers formed of the mixtures have low residual stress and good adhesiveness with the recording layer. Further, the protective layers formed of the mixtures hardly deteriorate the recording sensitivity and erasure ratio of the recording medium even after repeated recording and erasure.

Specific examples of the method for forming the protective layers include vapor growth methods such as vacuum evaporation methods, sputtering methods, plasma chemical vapor deposition (CVD) methods, ion plating methods, and electron beam evaporation methods. Among these methods, sputtering methods are preferable because of having good productivity and producing films having good film properties.

The thickness of each of the lower and upper protective layers is determined in consideration of the targets of the properties of the recording medium such as reflectance, recording properties (e.g., record power margin, jitter properties and signal stability after repeated recording), and preservability (such as high temperature and high humidity preservation and heat cycle preservability). In general, the lower protective layer has a thickness of from 30 to 70 nm, and the upper protective layer has a thickness of from 3 to 30 nm. Particularly, the thickness of the upper protective layer, which largely influences cooling of the recording layer after recording, is preferably not less than 3 nm so that the recording medium has good erasure properties and good durability even after repeated recording. When the upper protective layer is too thin, the layer tends to be cracked, resulting in deterioration of the durability of the layer, and in addition the recording medium has poor recording sensitivity. In contrast, when the upper protective layer is too thick, a problem occurs in that the cooling speed of the recording layer is decreased, and thereby it becomes difficult to form record marks, resulting in formation of marks having a small area occurs.

### Reflection Layer

The reflection layer 6 is typically formed of one or more of materials such as metals such as Al, Au, Ag, Cu and Ta and metal alloys thereof. In addition, other elements such as Cr, Ti, Si, and Pd can be used in combination therewith. Among these materials, Ag or Ag alloys are preferably used for the reflection layer. This is because the reflection layer of the recording medium in the preferred embodiment of the present disclosure preferably has high heat conductivity (to control the cooling speed of the recording layer) and high reflectance (to improve contrast of reproduction signals utilizing interference effect). Since Ag has a very high heat conductivity of 427 W/m·K, it is preferable to use Ag or Ag alloys for the reflection layer. In this case, the recording layer can be rapidly cooled after being heated in a recording process, and therefore an amorphous mark can be easily formed in the recording layer.

In view of heat conductivity, pure Ag is most preferable for the reflection layer. However, in order to improve corrosion resistance of such a silver reflection layer, Cu is preferably added thereto. The added amount of Cu is preferably from 0.1 to 10 atomic %, and more preferably from 0.5 to 3 atomic %, in order not to deteriorate the properties of Ag. Addition of a large amount of Cu the silver reflection layer deteriorates the corrosion resistance of the reflection layer.

Specific examples of the method for forming the reflection layer include vapor growth methods such as vacuum evaporation methods, sputtering methods, plasma chemical vapor deposition (CVD) methods, ion plating methods, and electron beam evaporation methods. Among these methods, sputtering methods are preferable because of having good productivity and producing films having good film properties.

The reflection layer preferably has a thickness of not less than 100 nm, and more preferably not less than 200 nm to rapidly cool the recording layer. In view of the productivity and the in-plane thickness distribution of the reflection layer, the upper limit of the thickness of the reflection layer is about 300 nm.

### Barrier Layer

When pure silver or a silver alloy is used for the reflection layer and the upper protection layer includes a sulfur-containing material such as mixtures of ZnS and SiO₂, a problem in that the reflection layer is corroded due to a reaction of S with Ag occurs. Therefore, the recording medium has defects. Therefore it is preferable to form the barrier layer 5 between the upper protective layer and the reflection layer to prevent sulfurization of Ag included in the reflection layer.

The material for use in the barrier layer is required to have the following properties:

(1) good barrier ability to prevent sulfurization of Ag;
(2) good optical transparency against the laser light used;
(3) low heat conductivity to form amorphous marks;
(4) good adhesiveness with the upper protective layer and reflection layer; and
(5) ability to easily form the barrier layer.

From this point of view, oxides, carbides and nitrides are preferably used for the barrier layer. Specific examples thereof include oxides such as SiO, ZnO, SnO₂, Al₂O₃, TiO₂, and In₂O₃; nitrides such as Si₃N₄, AlN, TiN, Bn and ZrN; and carbides such as SiC. Among these materials, SiC is preferably used.

The barrier layer preferably has a thickness of from 3 to 10 nm.

### Resinous Protective Layer

The resinous protective layer 7 is formed to protect the above-mentioned thin layers during the manufacturing processes of the recording medium and after the recording medium is prepared. The resinous protective layer 7 is typically prepared by crosslinking an ultraviolet crosslinking resin. The thickness of the resinous protective layer 7 is preferably from 2 to 5 μm.

### Substrate

Suitable materials for use in the substrate 1 include glass, ceramics and resins. Among these materials, resins are preferably used in view of moldability and costs. Specific examples of the resins include polycarbonate resins, acrylic resins, epoxy resins, polystyrene resins, acrylonitrile-styrene copolymer resins, polyethylene resins, polypropylene resins, silicone resins, fluorine-containing resins, acrylonitrile-butadiene-styrene (ABS) resins, urethane resins, etc. Among these resins, polycarbonate resins, and acrylic resins are preferable in view of moldability, optical properties and costs.

It is preferable to form a wobbling groove, which has a depth of from 18 to 30 nm and a width of from 0.15 to 0.25 μm, on the substrate at a pitch of 0.40±0.01 μm. By forming such a wobbling groove, it becomes possible to access to a specific non-recorded track or to rotate the substrate at a constant linear velocity.

The thickness of the substrate 1 is not particularly limited, and is determined depending on the properties (such as wavelength of the laser used and focusing properties of the pickup lens) of the recording and reproduction apparatus for which the recording medium is used. Specifically, in a case of HD DVDs for which a laser having a wavelength of from 400 to 410 nm and a lens having a numerical aperture (NA) of 0.65 is used, a substrate having a thickness of 0.6 mm is used.

### Adhesive Layer

The adhesive layer is formed to adhere the substrate 1 with the other substrate 8. The adhesive layer is typically prepared using a double sided adhesive sheet in which an adhesive is coated on both sides of a film, or by coating and crosslinking a thermosetting resin or an ultraviolet crosslinking resin. The thickness of the adhesive layer is about 50 μm.

### Substrate 8

The other substrate 8 (hereinafter sometimes referred to as a dummy substrate) to be adhered to the recording medium is not necessarily transparent when an adhesive sheet or a thermosetting resin is used for the adhesive layer, but has to be transparent against ultraviolet light when an ultraviolet crosslinking resin is used for the adhesive layer. The dummy substrate 8 is typically made of the same material as that of the substrate 1, and has the same thickness of 0.6 mm.

The optical recording medium in the preferred embodiment of the present disclosure can be used as a multi-layer optical recording medium. FIG. 7 is a schematic view illustrating the cross section of an example (a two-layer optical recording medium) of the multi-layer optical recording medium. Referring to FIG. 7, the two-layer optical recording medium has a structure in that a first information layer 16, an intermediate layer 20, a second information layer 25 and a second substrate 30 are formed in this order overlying a first substrate 10. However, the multi-layer (two-layer) optical recording medium is not limited thereto.

The first information layer 16 includes a first lower protective layer 11, a first recording layer 12, a first upper protective layer 13, a first reflection layer 14, and a first heat diffusion layer 15. The second information layer 25 includes a second lower protective layer 21, a second recording layer 22, a second upper protective layer 23 and a second reflection layer 24.

A barrier layer can be formed between the first upper protective layer 13 and the first reflection layer 14 or between the second upper protective layer 23 and the second reflection layer 24.

When the two-layer optical recording medium is initialized, for example, at first, the second information layer is initialized by the method mentioned above, and then the first information layer is initialized.

The properties and materials of the upper and lower protective layers 11, 13, 21 and 23, recording layers 12 and 22, barrier layers and substrates 10 and 30 are the same as those of the upper and lower protective layers 1and 4, recording layer 3, barrier layer 5 and substrates 1 and 8, respectively.

The first reflection layer 14 preferably has a thickness of from 3 to 20 nm, and more preferably from 5 to 10 nm. It is hard to form a uniform layer having a thickness of less than 3 nm as the first reflection layer 14. When the first reflection layer 14 is too thick, it is hard to record and reproduce information in the second information layer 25 because the transparency of the layer 14 decreases.

### Interface Layer

The recording medium in the preferred embodiment of the present disclosure can include an interface layer between the first lower protective layer 11 and the first recording layer 12, and/or between the first recording layer 12 and the first upper protective layer 13 to prevent migration of a material between the layers during repeated recording operations or to accelerate crystallization of the recording layer, thereby improving the repeated recording properties of the recording medium.

Specific examples of the materials for use in the interface layer include nitrides such as Si—N, Al—N, Ti—N, Zr—N, and Ge—N; nitride oxides including the nitrides; carbides such as SiC; etc. Among these materials, Ge—N is preferably used because a layer of Ge—N can be easily formed using a reactive sputtering method and the resultant layer has good mechanical properties and good resistance to moisture. When the interface layer is too thick, the reflectance and absorptivity of the information layer are affected, resulting in deterioration of recording and reproduction performance of the recording medium. Therefore, the thickness of the interface layer is preferably from 1 to 10 nm and more preferably from 2 to 5 nm.

In addition, another interface layer, which is similar to the above-mentioned interface layer, can also be formed between the second lower protective layer 21 and the second recording layer 22, and/or between the second recording layer 22 and the second upper protective layer 23.

### First Heat Diffusion Layer

The first heat diffusion layer 15 is formed to rapidly cool the recording layer heated by a laser beam, and is required to have large heat conductivity. In addition, the first heat diffusion layer preferably has a small absorptivity against the laser light used for recording and reproduction so that information can be well recorded in the inner information layer (i.e., the second information layer) and the information therein can be well reproduced. Specifically, the heat diffusion layer 15 preferably has an extinction coefficient of not greater than 0.5, and more preferably not greater than 0.3. When the extinction coefficient is too large, recording and reproduction of information in the second information layer cannot be well performed.

In addition, the first heat diffusion layer 15 preferably has a refractive index of not less than 1.6 against the laser light used for recording and reproduction. When the refractive index is too low, it is hard to enhance the transparency of the first information layer.

Therefore, the first heat diffusion layer preferably includes at least one of nitrides, oxides, sulfides, nitride oxides, carbides, and fluorides. Specific examples of the materials for use in the first heat diffusion layer include AlN, Al₂O₃, SiC, SiN, TiO₂, SnO₂, In₂O₃, ZnO, indium-tin oxides (ITO), indium-zinc oxides (IZO), antimony-tin oxides (ATO), DLC (diamond-like carbon), BN, etc. Among these materials, materials including In₂O₃ as a main component are preferable, and ITO and IZO are more preferable. In this regard, the main component means a component which is included in an amount of not less than 50% by mole.

The first heat diffusion layer can be prepared by a method such as vapor growth methods, e.g., vacuum evaporation methods, sputtering methods, plasma chemical vapor deposition (CVD) methods, ion plating methods, and electron beam evaporation methods. Among these methods, sputtering methods are preferable because the methods have good productivity and the films produced by the methods have good film properties.

The first heat diffusion layer 15 preferably has a thickness of from 10 to 200 nm, and more preferably from 20 to 100 nm. Too thin a heat diffusion layer cannot produce a heat dissipation effect. Too thick a heat diffusion layer has a large stress and deteriorates the recording properties of the recording medium after repeated recording and productivity of the recording medium.

Another heat diffusion layer, which is similar to the first heat diffusion layer 15, can be formed between the lower protective layer and the first substrate to further improve the heat diffusion effect.

The intermediate layer 20 is formed so that the pickup used for recording and reproduction can optically distinguish the first information layer from the second information layer. The thickness thereof is preferably from 10 to 70 nm. When the intermediate layer is too thin, an inter-layer cross talk problem occurs. In contrast, when the intermediate layer is too thick, a spherical aberration problem occurs in recording and reproduction operations, thereby making it impossible to perform recording and reproduction.

The intermediate layer preferably has a low absorptivity against the laser light used for recording and reproduction. Suitable materials for use in the intermediate layer include resins because of having good moldability and low costs. Specifically, ultraviolet crosslinking resins, slow-acting resins, and thermoplastic resins can be preferably used therefor. In addition, double-sided adhesive tapes for use in adhering optical recording media (such as an adhesive sheet DA-8320 from Nitto Denko Corporation) can also be used for the intermediate layer.

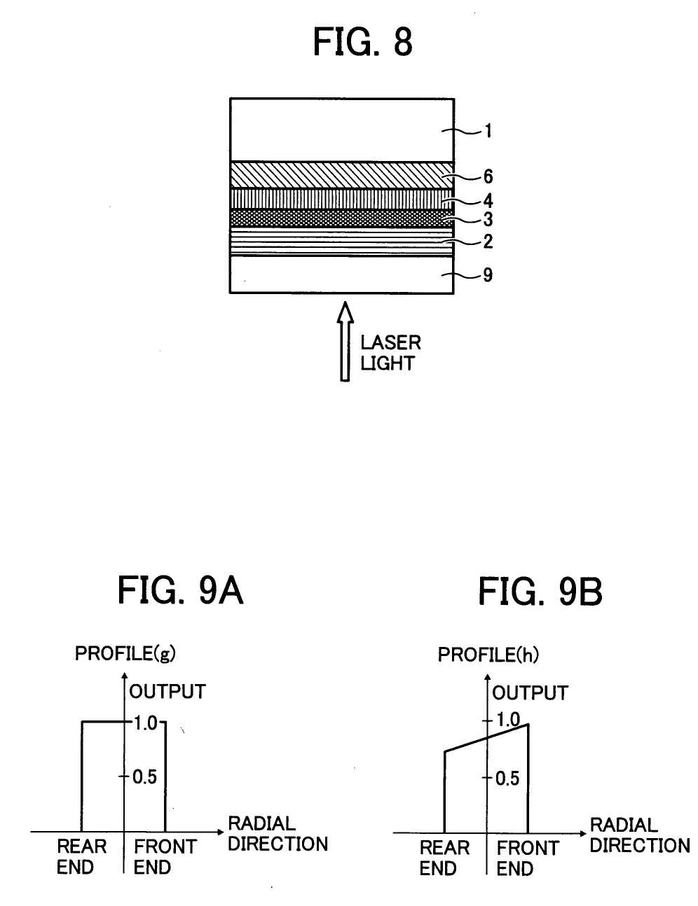

Hereinbefore, the optical recording medium in the preferred embodiment of the present disclosure is explained in detail. However, the optical recording medium in the preferred embodiment of the present disclosure is not limited to the examples mentioned above, and many changes and modifications can be made thereto without departing from the spirit and scope of the disclosure as set forth therein. For example, an optical recording medium having a structure illustrated in FIG. 8, which is similar to those of Blu-Ray discs, can also be used as the optical recording medium in the preferred embodiment of the present disclosure. The optical recording medium illustrated in FIG. 8 has the first substrate 1, and the reflection layer 6, the upper protective layer 4, the recording layer 3, the lower protective layer 2 and a light transmission layer 9 are formed in this order overlying the first substrate 1.

Having generally described the subject matter in preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Examples 1 to 6

A lower protective layer 2 constituted of ZnS (70% by mole)-SiO₂ (30% by mole) and having a thickness of 44 nm was formed on a polycarbonate resin substrate 1, which has a diameter of 12 cm and a thickness of 0.6 mm and on which a wobbling groove having a depth of 21 nm and a width of 0.20 μm had been formed at a track pitch of 0.40 μm, by a sputtering method using a sputtering device (DVD SPRINTER from Oerlikon Holdings AG). Next, a recording layer 3 constituted of a material having a formula of Ge_{19.5}Sb₅₉Sn₁₅Mn_{6.5} and a thickness of 12 nm was formed on the lower protective layer using the sputtering device. Further, an upper protective layer 4 constituted of ZnS (80% by mole)-SiO₂ (20% by mole) and having a thickness of 7 nm was formed on the recording layer using the sputtering device. Further, a barrier layer 5 constituted of SiC and having a thickness of 2 nm was formed on the upper protective layer using the sputtering device. Furthermore, a reflection layer 6 constituted of pure Ag and having a thickness of 180 nm was formed on the barrier layer using the sputtering device. Then the coated substrate was drawn from the sputtering device.

A resinous protective layer 7 was formed on the reflection layer by spin-coating an ultraviolet crosslinking resin (SD318 from Dainippon Ink and Chemicals, Inc. Then a polycarbonate resin substrate 8 having a diameter of 12 cm and a thickness of 0.6 mm was adhered to the resinous layer and ultraviolet light irradiated the laminated disc to crosslink the ultraviolet resin and to adhere the substrate 8 to the reflection layer with the resinous protective layer therebetween. Thus, a non-initialized optical recording medium was prepared.

The thus prepared optical recording medium was initialized under the initialization conditions illustrated in Table 1 below to prepare initialized optical recording media of Examples 1-6. The initialization method will be explained below.

### Example 7

The procedure for preparation of the non-initialized optical recording medium of Example 1 was repeated except that the material constituting the recording layer was changed to Ga₁₅Sb₆₂Sn₁₆Mn₁Te₆. The optical recording medium was initialized under the initialization conditions illustrated in Table 1 below.

### Example 8

The procedure for preparation of the non-initialized optical recording medium of Example 1 was repeated except that the material constituting the recording layer was changed to Ge₁₄Sb₆₁Sn₂₀Ga₃In₂. The optical recording medium was initialized under the initialization conditions illustrated in Table 1 below.

### Example 9

The procedure for preparation of the non-initialized optical recording medium of Example 1 was repeated except that the material constituting the recording layer was changed to Ge₁₅Sb₆₁Sn₂₀Zn₂Ag₂. The optical recording medium was initialized under the initialization conditions illustrated in Table 1 below.

### Example 10 and Comparative Examples 1 to 4

The procedure for preparation of the non-initialized optical recording medium of Example 1 was repeated. The optical recording medium was initialized under the initialization conditions illustrated in Table 1 below.

### Initialization Method

An initializing device, PCR DISK INITIALIZER from Hitachi Computer Peripherals Co., Ltd., was used for initializing each of the above-prepared media. Specifically, an elliptical laser beam irradiates the recording medium in such a manner that the long axis of the laser beam extends in the radial direction of the recording medium while rotating the recording medium at a linear velocity of from 6 to 12 m/s in the track direction of the recording medium and moving the laser beam in the radial direction of the recording medium by a distance (moving distance) shorter than the long axis diameter of the laser beam. The intensity of the laser beam has the maximum intensity peak at a rear end thereof relative to the moving direction of the laser beam (i.e., in the radial direction of the recording medium). The laser beam used for initialization in Examples 1-10 had one of the profiles (a)-(f) illustrated in FIGS. 5A-5F. The ratio (MIN/MAX) of the intensity (MIN) of the minimum peak to the intensity (MAX) of the maximum peak in the profile was changed from 60 to 75% as illustrated in Table 1. In addition, the power density of the peak of the laser beam was changed from 13 to 17 mW/μm² as illustrated in Table 1.

The laser beam used for initialization in Comparative Examples 1-3 had the profile (g) illustrated in FIG. 9A and the laser beam used for initialization in Comparative Example 4 had the profile (h) illustrated in FIG. 9B.

### Method for Evaluating Recording Property

The method for evaluating the recording property of each recording medium is as follows. Signals of 2 T to 11 T were repeatedly recorded in all the data regions of the recording medium using an Eight To Twelve Modulation (ETM) method to determine the average of DOW1PRSNR by which deterioration of the recording property in initial repeated recording can be well expressed. The recording conditions are as follows.

1. Disk evaluation device: ODU-1000 from Pulstec Industrial Co., Ltd.

1) Wavelength of laser light: 405 nm

2) Numerical aperture of pickup: 0.65

2. Linear velocity in recording: 6.61 m/s (single speed of HD DVD) (except for Example 10); 13.22 m/s for Example 10 (double speed of HD DVD)
3. Line density in recording: 0.153 μm/bit
4. Linear velocity in reproduction: 6.61 m/s
5. Power of reproduction light: 0.4 mW

Since the property DOW1 of high speed recording media tends to easily deteriorate with time, the evaluation is performed soon after the initialization operation (i.e., within a few hours after the initialization operation).

The recording property of the media is graded into the following three categories.

### ⊚: The average of DOW1PRSNR is not less than 16.0. (excellent)

### O: The average of DOW1PRSNR is not less than 15.0 and less than 16.0. (good)

### X: The average of DOW1PRSNR is less than 15.0. (unacceptable)

The average of DOW1PRSNR is preferably not less than 15.0, and is more preferably not less than 16.0 to maintain a stable system.

### Evaluation of Variation of Recording Property

In order to evaluate variation of the recording property of the recording medium, the inter-track standard deviation (σ) of DOW1PRSNR in all the data regions was obtained. The reproduction velocity was 6.61 m/s and the reproduction power was 0.4 mW.

The variation of recording property of the media is graded into the following two categories.

### O: The standard deviation (σ) is not greater than 3.0. (good)

### X: The standard deviation (σ) is greater than 3.0. (unacceptable)

When the standard deviation is not greater than 3.0, the recording medium has uniform and good recording property.

### Preservation Reliability

The procedure for evaluation of the recording property was repeated except that evaluation was performed after the recording medium had been allowed to settle in a chamber in which the temperature and humidity are controlled to be 80° C. and 85% RH.

Similarly to the recording property, the preservation reliability of the media is graded into the following three categories.

### ⊚: The average of DOW1PRSNR is not less than 16.0. (excellent)

### O: The average of DOW1PRSNR is not less than 15.0 and less than 16.0. (good)

### X: The average of DOW1PRSNR is less than 15.0. (unacceptable)

The evaluation results are shown in Table 2.

TABLE 1

| | | Initialization | | | |
|---|---|---|---|---|---|
| | | scanning | | | |
| | | speed in | | | |
| | Power | track | Moving | Beam | |
| | density | direction | distance | intensity | MIN/MAX |
| | (mW/μm²) | (m/s) | (μm/r) | Profile | (%) |
| Ex. 1 | 14 | 9 | 50 | (a) | 75 |
| Ex. 2 | 10 | 6 | 50 | (a) | 75 |
| Ex. 3 | 17 | 12 | 35 | (a) | 75 |
| Ex. 4 | 14 | 9 | 50 | (e) | 60 |
| Ex. 5 | 14 | 9 | 50 | (b) | 60 |
| Ex. 6 | 14 | 9 | 50 | (f) | 75 |
| Ex. 7 | 14 | 9 | 50 | (a) | 75 |
| Ex. 8 | 13 | 9 | 50 | (a) | 75 |
| Ex. 9 | 14 | 9 | 50 | (a) | 75 |
| Ex. 10 | 14 | 9 | 50 | (a) | 75 |
| Comp. | 14 | 9 | 50 | (g) | (100) |
| Ex. 1 | | | | | |
| Comp. | 10 | 6 | 70 | (g) | (100) |
| Ex. 2 | | | | | |
| Comp. | 17 | 12 | 35 | (g) | (100) |
| Ex. 3 | | | | | |
| Comp. | 14 | 9 | 50 | (f) | 75 |
| Ex. 4 | | | | | |

TABLE 2

| | | Standard | |
|---|---|---|---|
| | Average of | deviation of | Preservation |
| | DOW1PRSNR | DOW1PRSNR | reliability |
| Ex. 1 | ⊚ | ◯ | ⊚ |
| Ex. 2 | ⊚ | ◯ | ⊚ |
| Ex. 3 | ⊚ | ◯ | ⊚ |
| Ex. 4 | ⊚ | ◯ | ⊚ |
| Ex. 5 | ⊚ | ◯ | ⊚ |
| Ex. 6 | ⊚ | ◯ | ⊚ |
| Ex. 7 | ⊚ | ◯ | ⊚ |
| Ex. 8 | ⊚ | ◯ | ◯ |
| Ex. 9 | ◯ | ◯ | ◯ |
| Ex. 10 | ◯ | ◯ | ◯ |
| Comp. Ex. 1 | ⊚ | X | Not evaluated |
| Comp. Ex. 2 | ⊚ | X | Not evaluated |
| Comp. Ex. 3 | ◯ | X | Not evaluated |
| Comp. Ex. 4 | X | X | Not evaluated |

It is clear from Table 2 that the media of Examples 1-10 are superior to the media of Comparative Examples 1-4.

### Examples 11 and Comparative Example 5

A first lower protective layer 11 constituted of ZnS (70% by mole)-SiO₂ (30% by mole) and having a thickness of 40 nm was formed on a polycarbonate resin substrate 1, which has a diameter of 12 cm and a thickness of 0.6 mm and on which a wobbling groove having a depth of 20 nm and a width of 0.20 μm had been formed at a track pitch of 0.40 μm, by a sputtering method using a sputtering device (DVD SPRINTER from Oerlikon Holdings AG). Next, a first recording layer 12 constituted of a material having a formula of Ge₅Sb₇₄Te₂₁ and a thickness of 7 nm was formed on the first lower protective layer using the sputtering device. Further, a first upper protective layer 13 constituted of Zr₂O₃ (70% by mole)-TiO₂ (30% by mole) and having a thickness of 20 nm was formed on the first recording layer using the sputtering device. Further, a first reflection layer 14 constituted of Ag and having a thickness of 10 nm was formed on the first upper protective layer. Furthermore, a first heat diffusion layer 15 constituted of an IZO (i.e., (In₂O₃)₉₀.(ZnO)₁₀) and having a thickness of 23 nm was formed on the first reflection layer using the sputtering device. The sputtering operation was performed in an argon atmosphere. Thus, the first information layer 16 was formed.

Next, a second reflection layer 24 constituted of Ag and having a thickness of 140 nm was formed on a second substrate, which is the same polycarbonate resin substrate as that of the first substrate and serves as the second substrate 30 in FIG. 7. Then a second upper protective layer 23 constituted of Zr₂O₃ (70% by mole)-TiO₂ (30% by mole) and having a thickness of 25 nm was formed on the second reflection layer. Further, a second recording layer 23 constituted of a material having a formula of Ag₁In₂Ge₅Sb₇₂Te₂₀ and a thickness of 11 nm was formed on the second upper protective layer. A second lower protective layer 21 constituted of ZnS (70% by mole)-SiO₂ (30% by mole) and having a thickness of 65 nm was formed on the second recording layer. The sputtering operation was performed in an argon atmosphere using the sputtering device mentioned above. Thus, the second information layer 25 was formed.

Next, an intermediate layer 20 was formed on the reflection layer by spin-coating an ultraviolet crosslinking resin (SD318 from Dainippon Ink and Chemicals, Inc.). Then the second information layer formed on the second resin substrate 30 was adhered to the intermediate layer and ultraviolet light irradiated the laminated disc from the first substrate side to crosslink the ultraviolet resin. The intermediate layer has a thickness of 25 μm. Thus, a non-initialized two-layer optical recording medium for Example 11 and Comparative Example 5, which has the structure illustrated in FIG. 7, was prepared.

The second information layer of the thus prepared optical recording medium was initialized, followed by initialization of the first information layer to prepare initialized optical recording media of Example 11 and Comparative Example 5. The initialization method is the same as that mentioned above in Example 1 and the initialization conditions are illustrated in Table 3 below.

The thus initialized recording media were evaluated in the above-mentioned method. The results are shown in Table 4.

TABLE 3

| | | | Initialization | | | |
|---|---|---|---|---|---|---|
| | | | scanning | | | |
| | | | speed in | | | |
| | | Power | track | Moving | Beam | MIN/ |
| | | density | direction | distance | intensity | MAX |
| | | (mW/μm²) | (m/s) | (μm/r) | profile | (%) |
| Ex. | First | 12 | 6 | 35 | (a) | 75 |
| 11 | Info. | | | | | |
| | layer | | | | | |
| | Second | 11 | 3 | 35 | (a) | 75 |
| | Info. | | | | | |
| | layer | | | | | |
| Comp. | First | 12 | 6 | 35 | (g) | (100) |
| Ex. 5 | Info. | | | | | |
| | layer | | | | | |
| | Second | 11 | 3 | 35 | (g) | (100) |
| | Info. | | | | | |
| | layer | | | | | |

TABLE 4

| | | | Standard | |
|---|---|---|---|---|
| | | Average of | deviation of | Preservation |
| | | DOW1PRSNR | DOW1PRSNR | reliability |
| 1 | First | ◯ | ◯ | ◯ |
| | Info. | | | |
| | layer | | | |
| | Second | ⊚ | ◯ | ◯ |
| | Info. | | | |
| | layer | | | |
| Comp. | First | X | X | Not evaluated |
| Ex. 5 | Info. | | | |
| | layer | | | |
| | Second | ◯ | X | Not evaluated |
| | Info. | | | |
| | layer | | | |

It is clear from Table 4 that the medium of Example 11 is superior to the medium of Comparative Example 5.

### Example 12

The procedure for preparation of the non-initialized recording medium in Example 11 was repeated except that the material constituting the first heat diffusion layer was changed to ITO (i.e., (In₂O₃)₉₀.(SnO₂)₁₀).

### Example 13

The procedure for preparation of the non-initialized recording medium in Example 11 was repeated except that the material constituting the second reflection layer was changed to Ag in which Bi is included in an amount of 0.5 atomic %.

The thus prepared non-initialized optical recording media of Examples 12 and 13 were initialized and evaluated with respect to the recording properties and preservation reliability by the method performed on the medium of Example 11. As a result, it was found that the media have good properties such that the average of DOW1PRSNR is not less than 15.0 and the standard deviation thereof is not greater than 0.3.

### Example 14 and Comparative Example 6

The procedure for preparation of the non-initialized recording medium in Example 1 was repeated except that the material constituting the recording layer was changed to In₂₁Sb₇₃Ge₆, the material constituting the upper protective layer was changed to Nb₂O₅ (80% by mole)-ZrO₂ (20% by mole), and the barrier layer was not formed. The thus prepared non-initialized recording medium was used for Example 14 and Comparative Example 6.

### Example 15

The procedure for preparation of the non-initialized recording medium in Example 14 was repeated except that the material constituting the recording layer was changed to In₁₉Sb₇₀Sn₇Ge₄.

### Example 16

The procedure for preparation of the non-initialized recording medium in Example 14 was repeated except that the material constituting the recording layer was changed to In₂₀Sb₇₀Te₅Ge₅.

### Example 17

The procedure for preparation of the non-initialized recording medium in Example 14 was repeated except that the material constituting the recording layer was changed to In₂₀Sb₇₀Te₂Zn₈.

The thus prepared non-initialized optical recording media of Examples 14 to 17 and Comparative Example 6 were initialized and evaluated with respect to the recording properties and preservation reliability by the method performed on the medium of Example 1. The recording velocity was 13.22 m/s, which is the same as that in Example 10.

The initialization conditions are shown in Table 5 and the evaluation results are shown in Table 6.

TABLE 5

| | | Initialization | | | |
|---|---|---|---|---|---|
| | | scanning | | | |
| | | speed in | | | |
| | Power | track | Moving | Beam | |
| | density | direction | distance | intensity | MIN/MAX |
| | (mW/μm²) | (m/s) | (μm/r) | profile | (%) |
| Ex. 14 | 17 | 12 | 50 | (e) | 75 |
| Ex. 15 | 14 | 9 | 50 | (e) | 75 |
| Ex. 16 | 15 | 10 | 50 | (e) | 75 |
| Ex. 17 | 10 | 6 | 50 | (e) | 75 |
| Comp. | 16 | 12 | 50 | (g) | (100) |
| Ex. 6 | | | | | |

TABLE 6

| | | Standard | |
|---|---|---|---|
| | Average of | deviation of | Preservation |
| | DOW1PRSNR | DOW1PRSNR | reliability |
| Ex. 14 | ⊚ | ◯ | ⊚ |
| Ex. 15 | ⊚ | ◯ | ⊚ |
| Ex. 16 | ⊚ | ◯ | ◯ |
| Ex. 17 | ⊚ | ◯ | ⊚ |
| Comp. Ex. 6 | ⊚ | X | Not evaluated |

It is clear from Table 6 that the recording media of Examples 14-17 are superior to the recording medium of Comparative Example 6.

### Example 18

The procedure for preparation of the non-initialized recording medium in Example 11 was repeated except that the first heat diffusion layer was changed to a TiO₂ layer having a thickness of 20 nm, and the material constituting the second lower protective layer was changed to ZnS (80% by mole)-SiO₂ (20% by mole).

### Example 19

The procedure for preparation of the non-initialized recording medium in Example 18 was repeated except that the material constituting the recording layer was changed to Ag_{0.2}In_{1.5}Ge_{4.5}Sb_{71.3}Te_{22.5}.

The thus prepared n on-initialized optical recording media of Examples 18 and 19 were initialized and evaluated with respect to the recording properties and preservation reliability by the method performed on the medium of Example 11. As a result, it was found that the media have good properties such that the average of DOW1PRSNR is not less than 15.0 and the standard deviation thereof is not greater than 0.3.

This document claims priority and contains subject matter related to Japanese Patent Application No. 2006-060126, filed on Mar. 6, 2006, the entire contents of which are incorporated herein by reference.

Having now described the subject matter in the preferred embodiment of the disclosure, it will be apparent to one of ordinary skill in the art that many changes and modifications can be made thereto without departing from the spirit and scope of the disclosure as set forth therein. For example, elements and/or features of different examples and illustrative embodiments may be combined with each other and/or substituted for each other within the scope of this disclosure and appended claims.

What is claimed is:

1. An optical recording medium comprising:
a transparent substrate; and
at least one multi-layer information layer located overlying the transparent substrate and comprising:
a phase change recording layer configured to record information by changing phase thereof between a crystallization state and an amorphous state,
a protective layer, and
a reflection layer,
wherein an average of partial response signal-to-noise ratio (PRSNR) in all data regions of the recording medium is not less than 15.0 after one direct overwriting (DOW1) cycle and a standard deviation of inter-track distribution of PRSNR is not greater than 0.3.

2. The optical recording medium according to claim 1, wherein a wobbling groove having a depth of from 18 to 30 nm and a width of from 0.15 to 0.25 μm is formed on the transparent substrate at a pitch of 0.40±0.01 μm.

3. The optical recording medium according to claim 1, wherein the optical recording medium is initialized by a method comprising:
irradiating the optical recording medium with a rectangular or elliptical-form laser beam in such a manner that a long axis of the laser beam extends in a radial direction of the optical recording medium while rotating the optical recording medium at a linear velocity and moving the laser beam in the radial direction of the optical recording medium by a distance, which is shorter than a long-axis diameter of the laser beam, per one revolution of the recording medium, wherein the laser beam has an beam intensity profile such that a maximum intensity peak is present on a rear side of the profile relative to the moving direction of the optical recording medium.

4. The optical recording medium according to claim 3, wherein the laser beam has an intensity peak at a rear end thereof.

5. The optical recording medium according to claim 3, wherein the laser beam has a beam intensity profile such that intensity of the laser beam decreases from the maximum intensity peak toward a front end of the intensity profile.

6. The optical recording medium according to claim 3, wherein the linear velocity of the optical recording medium is from 3 to 14 m/s and the laser beam has a power density of from 5 to 25 mW/μm².

7. The optical recording medium according to claim 1, wherein the recording layer comprises a Sb—Te based phase change material.

8. The optical recording medium according to claim 1, wherein the recording layer comprises a Ge—Sb—Sn based phase change material.

9. The optical recording medium according to claim 8, wherein the recording layer further comprises at least one element selected from the group consisting of In, Te, Al, Ga, Zn, Mg, Tl, Bi, Se, C, N, Au, Ag, Cu, Mn and rare earth elements in a total amount of from 0.1 to 10 atomic %.

10. The optical recording medium according to claim 1, wherein the recording layer has a thickness of from 4 to 18 nm.

11. The optical recording medium according to claim 1, including two or more information layers which are overlaid, wherein each of the information layers comprises a phase change recording layer configured to record information by changing phase thereof between a crystallization state and an amorphous state, a protective layer, and a reflection layer.

12. The optical recording medium according to claim 11, including two information layers which are overlaid, wherein the first information layer comprises a first lower protective layer, a first recording layer, a first upper protective layer, a first reflection layer, and a first heat diffusion layer, which are located overlying the transparent substrate in this order, and the second information layer comprises a second lower protective layer, a second recording layer, a second upper protective layer, and a second reflection layer, which are located overlying the first information layer in this order.

13. The optical recording medium according to claim 12, further comprising:
an interface layer at least one of a position between the first lower protective layer and the first recording layer or a position between the first recording layer and the first upper protective layer.

14. The optical recording medium according to claim 12, wherein the first heat diffusion layer comprises In₂O₃ as a main component.

15. The optical recording medium according to claim 14, wherein the first heat diffusion layer comprises at least one of an indium tin oxide or an indium zinc oxide as a main component.

16. The optical recording medium according to claim 12, wherein the first heat diffusion layer has a thickness of from 10 to 200 nm.

17. The optical recording medium according to claim 12, wherein each of the first reflection layer and the second reflection layer comprises Ag or an Ag alloy.

18. A method for initializing the optical recording medium according to claim 1, comprising:
irradiating the optical recording medium with a rectangular or elliptical-form laser beam in such a manner that a long axis of the laser beam extends in a radial direction of the optical recording medium while rotating the optical recording medium at a linear velocity and moving the laser beam in the radial direction of the optical recording medium by a distance, which is shorter than a long-axis diameter of the laser beam, per one revolution of the recording medium, wherein the laser beam has a beam intensity profile such that a maximum intensity peak is present on a rear side of the profile relative to the moving direction of the optical recording medium.

19. The method according to claim 18, wherein the laser beam has a beam intensity profile such that intensity of the laser beam decreases from the maximum intensity peak toward a front end of the profile.

20. The method according to claim 18, wherein the linear velocity of the optical recording medium is from 3 to 14 m/s and the laser beam has a power density of from 5 to 25 mW/μm².
